(19) United States
(12) Patent Application Publication
(10) Pub. No.: US 2025/0158302 A1
(43) Pub. Date: May 15, 2025

(54) CONNECTOR-BOARD ASSEMBLY, AND ELECTRONIC APPARATUS

(71) Applicant: Lenovo (Singapore) Pte. Ltd., Singapore (SG)

(72) Inventors: Fumitake Mizoguchi, Kanagawa (JP); Osamu Ohsawa, Kanagawa (JP); Yoshiyuki Shibayama, Kanagawa (JP); Masaaki Bandoh, Kanagawa (JP); Munefumi Nakata, Kanagawa (JP)

(73) Assignee: Lenovo (Singapore) Pte. Ltd., Singapore (SG)

(21) Appl. No.: 18/916,002

(22) Filed: Oct. 15, 2024

(30) Foreign Application Priority Data
Nov. 15, 2023 (JP) 2023-194200

(51) Int. Cl. H01R 12/71; G06F 1/16; G06F 1/18; H01R 13/502; H01R 13/6581

(52) U.S. Cl. CPC H01R 12/716; H01R 13/502; G06F 1/1616; G06F 1/183; H01R 13/6581; H01R 2201/06

(57) ABSTRACT

A connector-board assembly allows a receptacle connector to be replaced. A receptacle connector and a board in a connector-board assembly are arranged so that a first relay connector on the receptacle connector side and a second relay connector on the board side are detachably connected to each other. The receptacle connector includes an electrode line continuously extending from an electrode connected to a plug-side electrode to a relay terminal of the first relay connector, and a holder which covers and holds the electrode line between the electrode and the relay terminal.

### CROSS-REFERENCE TO RELATED APPLICATIONS

This application claims priority to Japanese Patent Application No. 2023-194200 filed on Nov. 15, 2023, the contents of which are hereby incorporated herein by reference in their entirety.

### BACKGROUND OF THE INVENTION

### Field of the Invention

The present invention relates to a connector-board assembly having a receptacle connector and a board mounted with the receptacle connector, and an electronic apparatus.

### Description of the Related Art

A laptop or tablet PC has a receptacle connector on the side of a flat-shaped chassis. The receptacle connector is often mounted on the edge of a main board (Japanese Unexamined Patent Application Publication No. 2019-36484).

### SUMMARY OF THE INVENTION

Meanwhile, although the receptacle connector itself is relatively inexpensive, if the receptacle connector is subjected to an excessive force than expected and is damaged, it will need to be replaced along with the main board on which it is mounted, so that there is a concern that a cost burden on a user will increase.

The present invention has been made in view of the above problems. One or more embodiments of the present invention provide a connector-board assembly which allows a receptacle connector to be replaced individually, and an electronic apparatus.

A connector-board assembly according to a first aspect of the present invention includes a receptacle connector and a board mounted with the receptacle connector. In the connector-board assembly, the receptacle connector and the board are arranged so that a first relay connector on the receptacle connector side and a second relay connector on the board side are detachably connected to each other. The receptacle connector includes an electrode line continuously extending from an electrode connected to a plug-side electrode to a relay terminal of the first relay connector, and a holder which covers and holds the electrode line between the electrode and the relay terminal.

An electronic apparatus according to a second aspect of the present invention includes a receptacle connector and a board mounted with the receptacle connector. In the electronic apparatus, the receptacle connector and the board are arranged so that a first relay connector on the receptacle connector side and a second relay connector on the board side are detachably connected to each other. The receptacle connector includes an electrode line continuously extending from an electrode connected to a plug-side electrode to a relay terminal of the first relay connector, and a non-flexible holder which covers and holds the electrode line between the electrode and the relay terminal.

According to the above-described aspects of present invention, the receptacle connector mounted on the board can be replaced individually.

### BRIEF DESCRIPTION OF THE DRAWINGS

FIG. 1 is a perspective view of a laptop PC according to an embodiment of the present invention;

FIG. 2 is a perspective view of a receptacle connector according to a first embodiment as viewed from diagonally outside;

FIG. 3 is a perspective view of the receptacle connector according to the first embodiment as viewed from diagonally inside;

FIG. 4 is a perspective view of a receptacle connector according to a modification as viewed from diagonally inside;

FIG. 5 is a cross-sectional side view taken along line V-V in FIG. 2;

FIG. 6 is a perspective view of the receptacle connector according to the first embodiment with a first shell and a second shell removed;

FIG. 7 is a view illustrating modifications of a folded portion, in which FIG. 7A is a schematic view illustrating a folded portion according to a first modification, FIG. 7B is a schematic view illustrating a folded portion according to a second modification, FIG. 7C is a schematic view illustrating a folded portion according to a third modification, and FIG. 7D is a schematic view illustrating a folded portion according to a fourth modification;

FIG. 8 is a schematic cross-sectional view of a board-to-board connector;

FIG. 9 is a schematic cross-sectional view of a board-to-board connector according to a modification;

FIG. 10 is an exploded perspective view of a receptacle connector, a board, and a chassis;

FIG. 11 is a view of a receptacle connector according to a second embodiment as viewed from outside;

FIG. 12 is a perspective view of the receptacle connector, board, and chassis according to the second embodiment as viewed from inside;

FIG. 13 is a perspective view illustrating a state in which two receptacle connectors according to a third embodiment are mounted on a board; and

FIG. 14 is a view illustrating the state of mounting of the two receptacle connectors according to the third embodiment on the board as viewed from outside.

### DETAILED DESCRIPTION OF THE INVENTION

Hereinafter, embodiments of a connector-board assembly and an electronic apparatus according to the present invention will be described in detail with reference to the accompanying drawings. Note that the present invention is not limited by the embodiments.

Examples of the connector-board assembly and the electronic apparatus according to the embodiments of the present invention will hereinafter be described in detail with reference to the accompanying drawings. Note that the present invention is not limited by the examples.

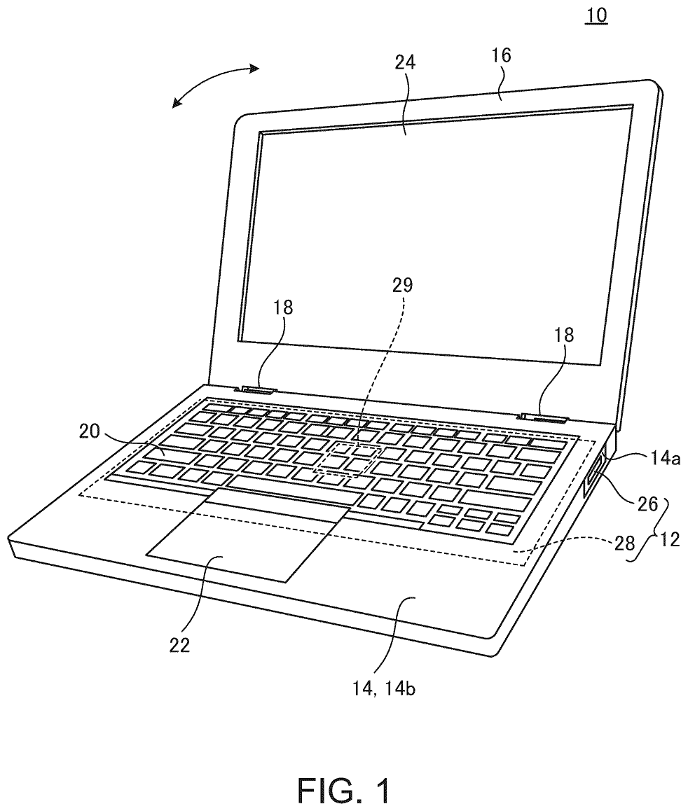

FIG. 1 is a perspective view of a laptop PC (electronic apparatus) 10 which serves as an electronic apparatus according to an embodiment of the present invention. The laptop PC10 includes a connector-board assembly 12 according to the embodiment of the present invention. The connector-board assembly 12 is incorporated inside a chassis 14 of the laptop PC10. The electronic apparatus according to the present invention is not limited to the laptop PC10 and may be, for example, a desktop PC or a mobile tablet terminal or the like.

The laptop PC10 includes a lid 16 which can be opened and closed by hinges 18 with respect to the chassis 14. The laptop PC 10 becomes compact by closing the lid 16 and is suitable for mobile use.

The chassis 14 is provided with a keyboard device 20 and a touch pad 22. A display device 24, which occupies most of the area of the front surface of the lid 16, and a speaker and a camera which are not illustrated in the drawing are provided on the front side of the lid 16.

The connector-board assembly 12 is incorporated into the chassis 14. The connector-board assembly 12 includes a receptacle connector 26 and a board 28. The board 28 serves as a main board in the laptop PC10 and is provided inside the chassis 14 across almost both left and right ends thereof. A CPU 29 which controls the entire laptop PC10 is mounted on the board 28. In the connector-board assembly 12, the board 28 on which the receptacle connector 26 is mounted may be a sub-board separate from the main board.

For convenience of description, the side of the chassis 13 is referred to as the outside around the receptacle connector 26, and conversely, the interior of the chassis 14 is referred to as the inside. Further, on the basis of the board 28, the side on which the majority of components are mounted is defined as the top, and its opposite side is defined as the bottom. This top-bottom reference may be opposite to that of the chassis 14 with the side on which the keyboard device 20 is provided being defined as the bottom. These directional names are given for the convenience of description, and the mode of usage of the electronic apparatus 10 is not limited thereto.

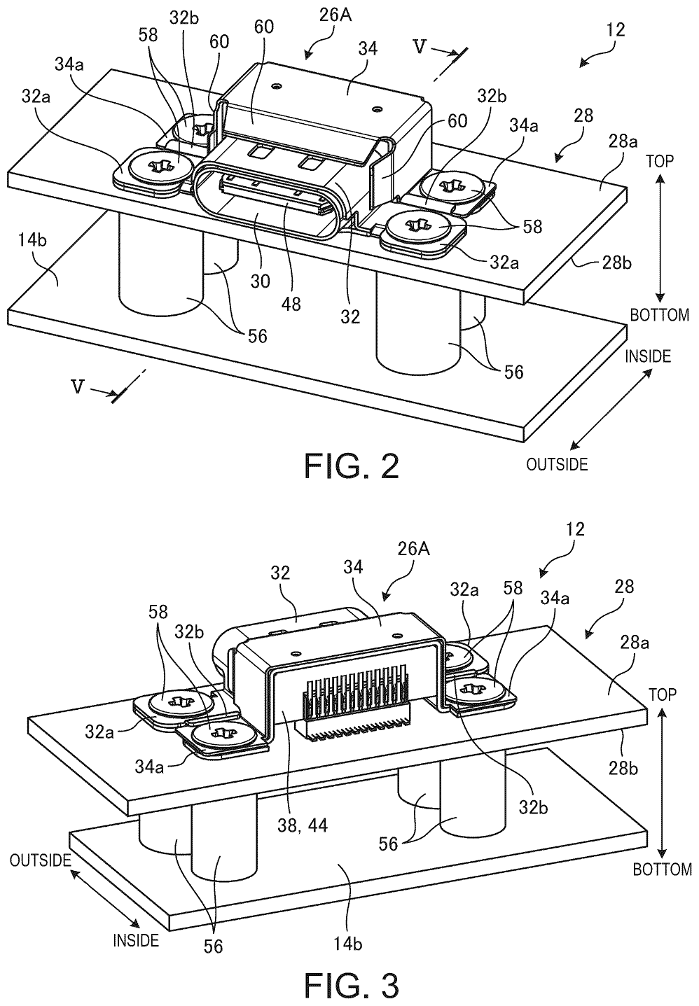

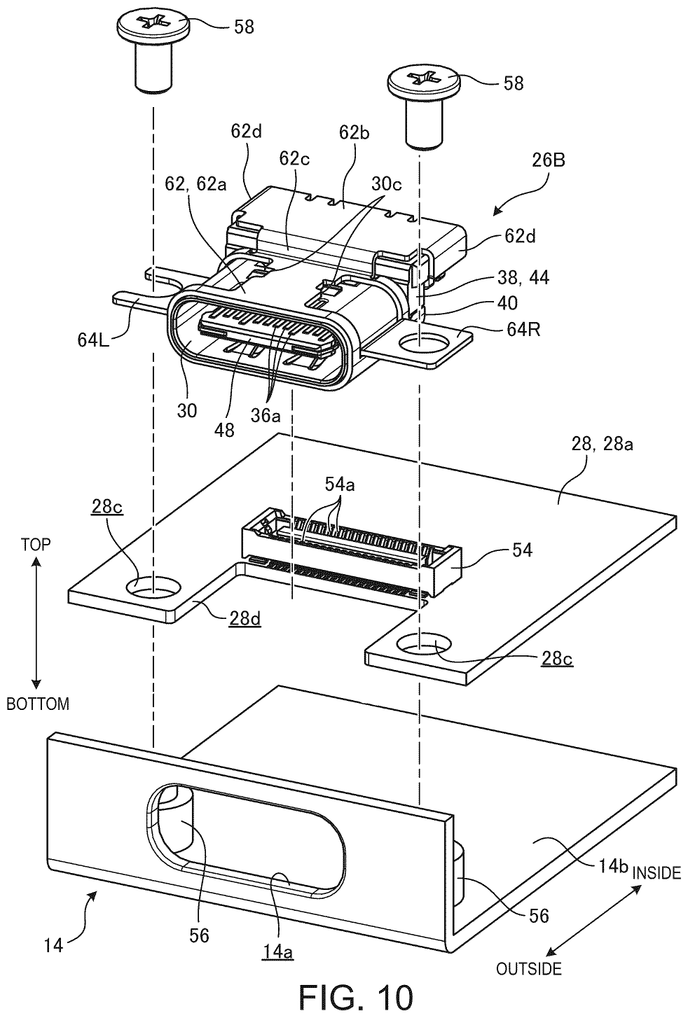

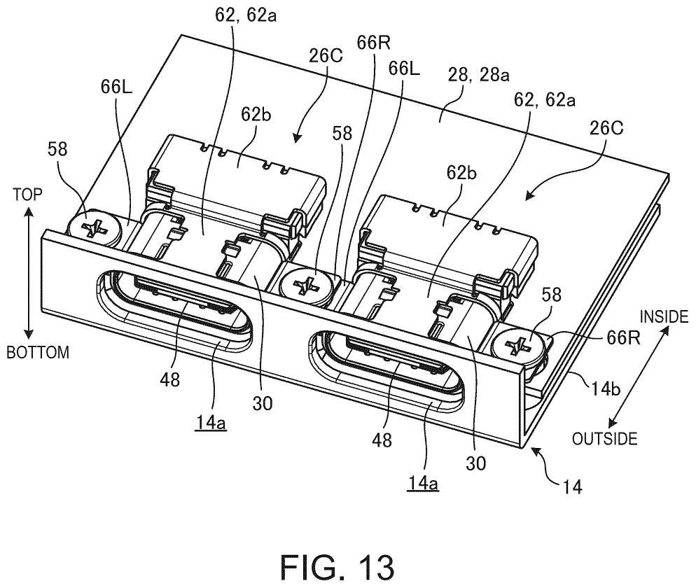

The receptacle connector 26 will be described below in order of a receptacle connector 26A according to a first embodiment (refer to FIG. 2), a receptacle connector 26B according to a second embodiment (refer to FIG. 10), and a receptacle connector 26C according to a third embodiment (refer to FIG. 13). The receptacle connectors 26A to 26C are, for example, standardized USB type-Cs or small connectors equivalent to the USB, and are used for data transmission and charging. The receptacle connectors 26A to 26C may be HDMI (High-Definition Multimedia Interface, registered trademark) or the like. Although the receptacle connectors 26A to 26C are mounted on the board 28, they are not soldered and are detachable therefrom.

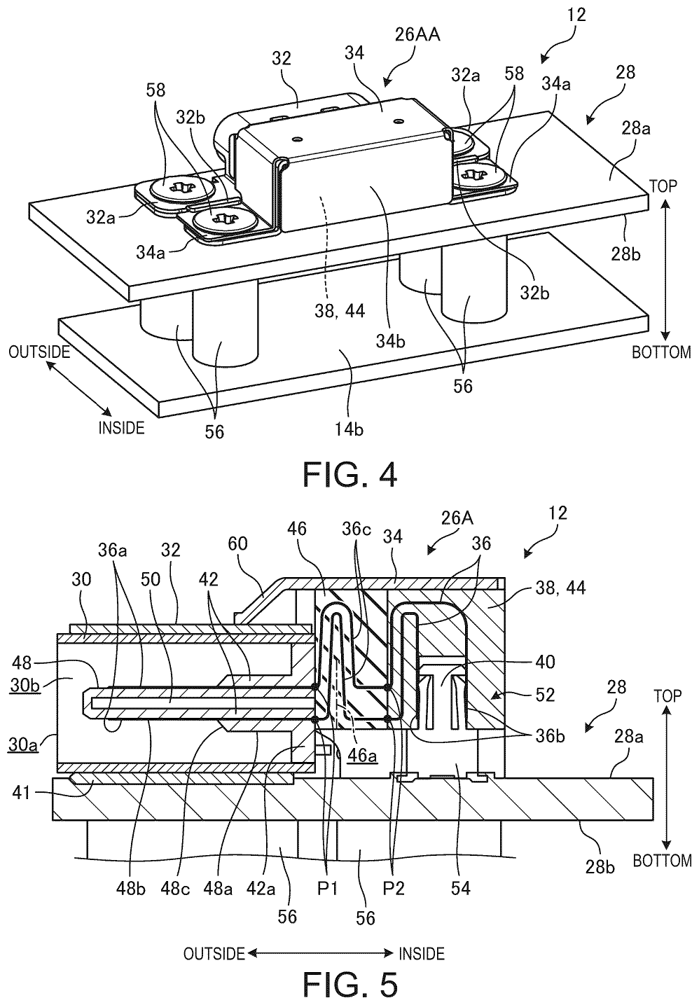

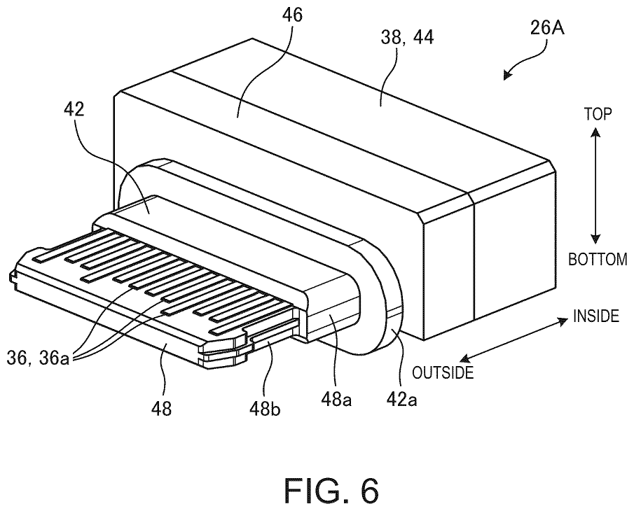

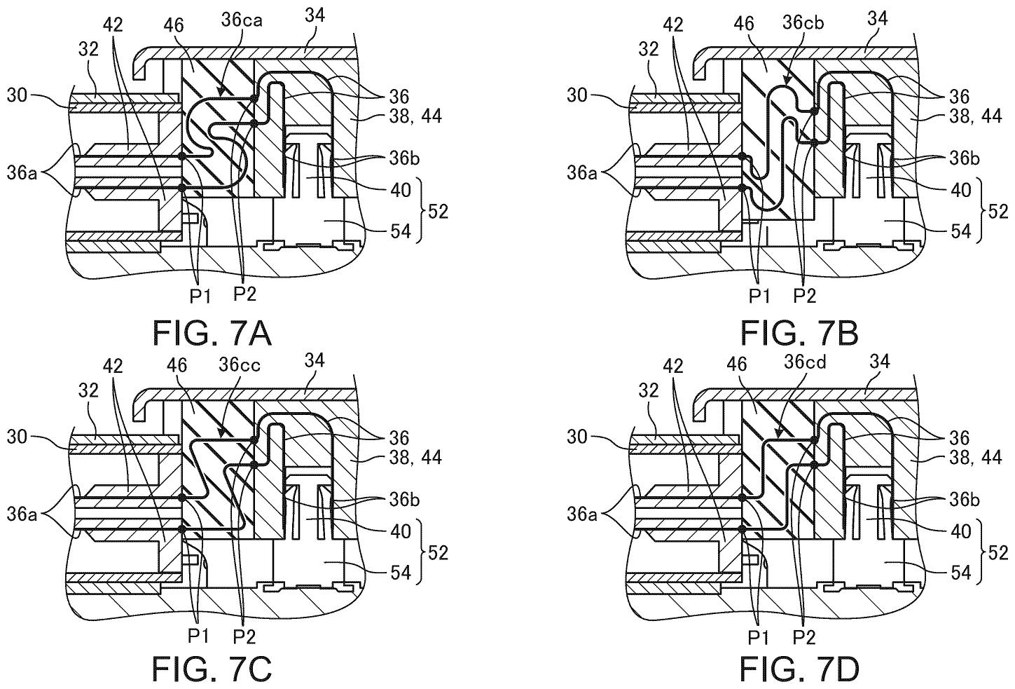

FIG. 2 is a perspective view of the receptacle connector 26A according to the first embodiment as viewed from diagonally outside. FIG. 3 is a perspective view of the receptacle connector 26A as viewed from diagonally inside. FIG. 4 is a perspective view of a receptacle connector 26AA according to a modification. FIG. 5 is a cross-sectional side view taken along line V-V in FIG. 1. FIG. 6 is a perspective view of the receptacle connector 26A with a plug holding cylindrical body 30 and shells 32 and 34 removed. FIG. 7 is a view illustrating modifications of a folded portion 36c, in which FIG. 7A is a schematic view illustrating a folded portion 36ca according to a first modification, FIG. 7B is a schematic view illustrating a folded portion 36cb according to a second modification, FIG. 7C is a schematic view illustrating a folded portion 36cc according to a third modification, and FIG. 7D is a schematic view illustrating a folded portion 36cd according to a fourth modification.

The receptacle connector 26A is a so-called top-mount type which is mounted on one surface of the board 28, and includes a plug holding cylindrical body 30, a first shell 32, a second shell 34, a plurality of electrode lines 36, a holding body 38, and a first relay connector 40. Of these, the plug holding cylindrical body 30 is located on the outermost side, and the first relay connector 40 faces downwards at the innermost position.

The plug holding cylindrical body 30 has a flat shape with rounded corners and is generally made of metal. A connector hole 14a (refer to FIG. 1) is formed in a side surface of the chassis 14, and a plug insertion opening 30a of the plug holding cylindrical body 30 is exposed from the connector hole 14a. A plug connector (not illustrated) is inserted and connected into a plug insertion hollow portion 30b corresponding to the inside of the plug insertion opening 30a. The plug connector can be inserted upside down. The plug holding cylindrical body 30 has a lower surface which is in a state of being placed on an upper surface of the board 28. A brand pattern 41 (refer to FIG. 5) is provided on the board 28 at a location on which the plug holding cylindrical body 30 is placed, to achieve electrical conduction.

The holding body 38 is a part which covers and holds the electrode lines 36. The holding body 38 covers the electrode lines 36 without any air gaps. The holding body 38 includes an outer electrode holder 42, an inner terminal holder 44, and an intermediate holder 46 between the electrode holder 42 and the terminal holder 44. The electrode holder 42, the terminal holder 44, and the intermediate holder 46 are integrally molded or their boundary portions are fixed by adhesion or the like. The holding body 38 is made of a resin material, but of these, the electrode holder 42 and the terminal holder 44 are basically made of the same material, whereas the intermediate holder 46 is made of a different material.

The electrode holder 42 and the terminal holder 44 are relatively hard and substantially rigid materials such as LCP (Liquid Crystal Polymer), and can securely hold the electrode lines 36. The intermediate holder 46 is a material having non-flexible volume elasticity, such as an elastomer (including natural rubber, silicone rubber, etc.). In the present application, non-flexibility means no flexibility. The flexibility is the property of allowing a sheet, a membrane, a string, etc. to be bent and flexed, and basically the volume remains almost unchanged even when deformed. In contrast, the volume elasticity is the property of changing the volume due to a change in pressure, and is essentially the same as compressibility. A material having flexibility tends to bend due to its own weight and is not able to maintain the shape thereof, whereas a material having non-flexible volume elasticity does not deform much under its own weight and can substantially maintain its shape.

Further, it is desirable that in terms of electrical characteristics, the electrode lines 36 do not come into contact with air on their way, and that the electrode holder 42, the terminal holder 44, and the intermediate holder 46 covering the surface have the same relative dielectric constant each other. This is because when the relative dielectric constant of the material covering the surface of the electrode line 36 differs significantly, so-called impedance matching becomes inconsistent, and a high-frequency signal is reflected.

On the other hand, since the electrode holder 42, the terminal holder 44, and the intermediate holder 46 are different in terms of required mechanical characteristics, it is difficult to make them completely identical in material and relative dielectric constant in design. The relative dielectric constants are set to be approximately equal within an allowable range. In the present embodiment, the relative dielectric constant of the LCP applied to the electrode holder 42 and the terminal holder 44 is about 3.4. In the present embodiment, the relative dielectric constant of the elastomer applied to the intermediate holder 46 is about 2.9 to 3.1. Thus, in order to prevent the impedance from becoming discontinuous in the receptacle connector 26, the electrode lines 36 are covered with a material having approximately the same relative dielectric constant in the corresponding portion inside the receptacle connector 26.

The electrode holder 42 has a flange portion 42a which mainly exists inside the plug holding cylindrical body 30 and is fitted into and fixed to the innermost portion of the plug holding cylindrical body 30, and a tongue portion 48 which protrudes outwardly from the flange portion 42a. The tongue portion 48 is located at an approximately middle in a vertical direction of the plug insertion hollow portion 30b of the plug holding cylindrical body 30, and extends from the flange portion 42a to the outside inside the plug holding cylindrical body 30. The tongue portion 48 has an outer tip portion 48b slightly thinner than an inner base portion 48a, and an inclined step 48c formed therebetween. The tip of the tongue portion 48 is located slightly inside an outer end of the plug holding cylindrical body 30. A metal plate 50 is provided at a vertical intermediate portion of the tongue portion 48. The metal plate 50 electromagnetically shields the tongue portion 48 at a vertical intermediate location and holds its strength.

The terminal holder 44 has a shape whose length and width are approximately equal when viewed from the side (refer to FIG. 5). In the present embodiment, the dimension in the inner-outer direction of the terminal holder 44 is about half that of the plug holding cylindrical body 30. The terminal holder 44 has a lower surface located slightly higher than the surface 28a of the board 28 and an upper surface located slightly higher than the plug holding cylindrical body 30. The terminal holder 44 is provided with a first relay connector 40 at its lower part. The entire terminal holder 44 may also serve as the first relay connector 40.

The intermediate holder 46 has a vertically long rectangular shape with its upper and lower surfaces located in the same positions as the terminal holder 44 when viewed from the side (refer to FIG. 5). The dimension in the inner-outer direction of the intermediate holder 46 is smaller than that of the terminal holder 44, and is about ⅓ of the plug holding cylindrical body 30 in the present embodiment.

The electrode line 36 continues from an electrode 36a connected to a plug-side electrode to a relay terminal 36b of the first relay connector 40, and is held by the holding body 38. The electrodes 36a are provided in two stages above and below the tongue portion 48, for a total of twenty-four electrodes provided above and below. The electrodes 36a are exposed on the upper and lower surfaces of the tip portion 48b and adapted to be in contact with electrodes of the plug connector.

The electrode line 36 has a folded portion 36c at a portion covered by the intermediate holder 46. The folded portion 36c turns upward at a steep angle inward from a boundary point P1 with the electrode holder 42, forms an inverted V shape, turns downward at a steep angle, and then reaches a boundary point P2 with the terminal holder 44 via a nearly horizontal portion. The boundary point P1 and the boundary point P2 are at the same height. Such a folded portion 36c can absorb a change in path length when the relative positions of the electrode holder 42 and the terminal holder 44 change. A thin slit 46a, as illustrated by an imaginary line, may be provided in the center of an inverted V-shape formed by the folded portion 36c to make it easier for the folded portion 36c to deform.

The folded portion 36c can take various forms as illustrated in FIG. 7. That is, between the boundary point P1 and the boundary point P2, the folded portion 36c may be an S-shape like the folded portion 36ca in FIG. 7A, a lateral S-shape like the folded portion 36cb in FIG. 7B, a Z-shape like the folded portion 36cc in FIG. 7C, or a crank shape like the folded portion 36cd in FIG. 7D. In other words, the electrode line 36 may have a curved or bent portion between the two points of the boundary point P1 and the boundary point P2.

The electrode line 36 enters into the terminal holder 44 from the boundary point P2, turns vertically upward toward the inside from the boundary point P2, forms an inverted U shape, turns vertically downward, and reaches the relay terminal 36b. The electrode lines 36 are arranged in two stages above and below the tongue portion 48 in the outer electrodes 36a, but are arranged in two rows in the inner and outer directions inside the first relay connector 40 in the inner relay terminals 36b.

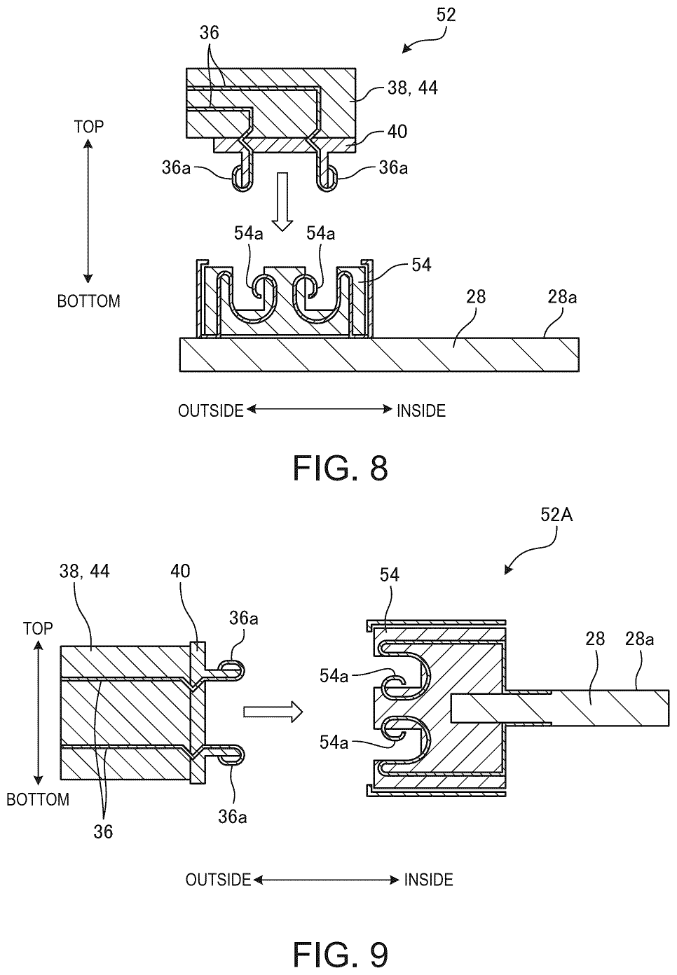

FIG. 8 is a schematic cross-sectional view of a board-to-board connector 52. The board-to-board connector 52 is constituted of a first relay connector 40 and a second relay connector 54. In the present embodiment, the first relay connector 40 has a plug structure, and the second relay connector 54 has a socket structure. The second relay connector 54 has two rows of relay terminals 54a in the inner and outer directions in association with the relay terminals 36b. The second relay connector 54 is fixed by soldering the relay terminals 54a to the surface 28a of the board 28. By lowering the first relay connector 40, the board-to-board connector 52 fits into an upward opening of the second relay connector 54, and the relay terminals 36b and the relay terminals 54a are brought into contact with each other and conduction. That is, the receptacle connector 26A and the board 28 are arranged so that the first relay connector 40 on the receptacle connector 26A side and the second relay connector 54 on the board 28 side are detachably connected to each other.

The first relay connector 40 and the second relay connector 54 have a floating structure capable of absorbing the tolerance between the relay terminals 36b and 54a. That is, the two rows of relay terminals 36b each have a J-shape with their curved tips facing in opposite directions, while the relay terminal 54a has one surface which is vertical along a housing wall, and the other surface curved so as to sandwich the relay terminal 36b, and the two rows of the relay terminals 54a are facing in opposite directions. In the relay terminal 36b and the relay terminal 54a, their straight and curved portions are elastically brought into contact with each other to allow the relative displacement between them while maintaining a conductive state in the up-down and inner-outer directions. They can also be displaced relative to each other while sliding in the direction perpendicular to the paper. Further, they are capable of relative displacement even in a rotational direction around each direction as an axis. The floating structure is not limited to this example.

FIG. 9 is a schematic cross-sectional view of a board-to-board connector 52A according to a modification. The board-to-board connector 52A has a second relay connector 54 which is a card edge type, and can be attached and detached by moving the first relay connector 40 in the inner and outer directions.

As illustrated in FIGS. 2 and 3, the plug holding cylindrical body 30 has side and upper surfaces covered by a first metal shell 32, and the intermediate holder 46 and the terminal holder 44 have side and upper surfaces covered by a second metal shell 34.

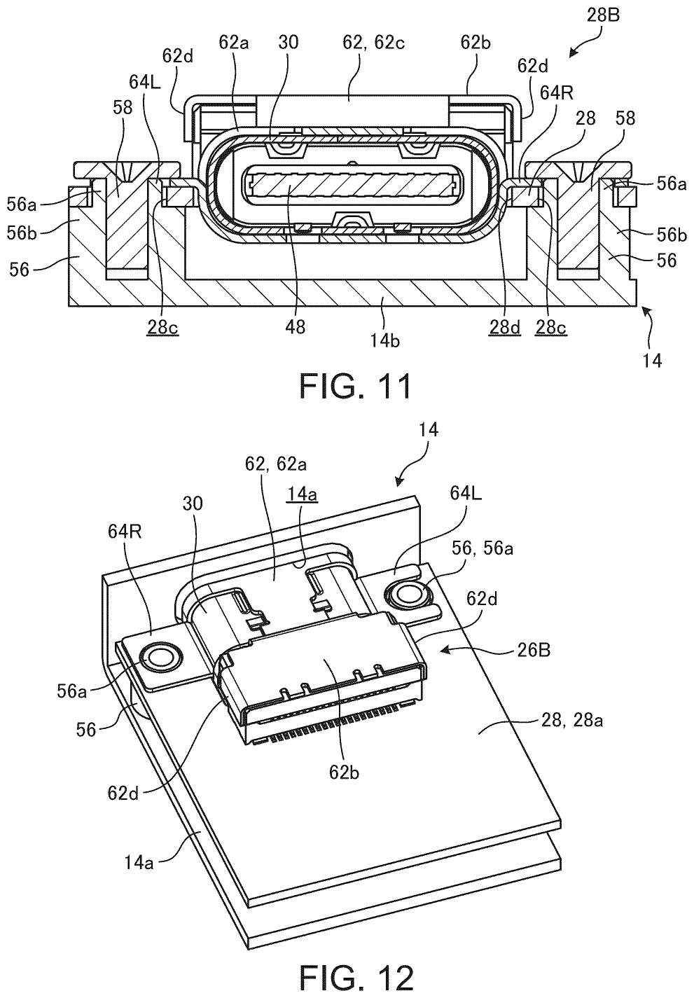

The first shell 32 is flattened and horseshoe-shaped, and the second shell 34 is rectangular and opened downward. When viewed from the outside (side into which the plug is inserted), the second shell 34 is larger than the first shell 32. When viewed from the outside, the first shell 32 has fixing pieces 32a fixed to the board 28, which are provided so as to protrude to both sides thereof. Similarly, the second shell 34 has fixing pieces 34a fixed to the board 28, which are provided so as to protrude to both sides thereof. The fixing pieces 32a and 34a are adjacent to each other in the inner and outer directions. The outer fixing piece 32a is provided with a pressing piece 32b which presses down the outer edge of the inner fixing piece 34a from above, thereby stabilizing and positioning the fixing piece 34a and ensuring electrical conduction between them. The fixing pieces 32a and 34a are formed with screw insertion holes. The board 28 has screw insertion holes 28c (refer to FIG. 11) formed at positions corresponding to the fixing pieces 32a and 34a.

Four studs 56 are provided upright on the inner side of an operation surface plate 14b (refer also to FIG. 1) of the chassis 14 at positions corresponding to the fixing pieces 32a and 34a. The top of the stud 56 has a stepped shape (refer to FIG. 11). A small diameter portion 56a fits into the screw insertion hole 28c of the board 28, and a large diameter portion 56b supports a back surface 28b of the board 28. When a screw 58 is screwed into the stud 56, the fixing pieces 32a and 34a and the board 28 are clamped and fixed by the head of the screw 58 and the large diameter portion 56b of the stud 56. That is, the fixing pieces 32a and 34a of the receptacle connector 26A are fixed to the board 28 via the studs 56 by the screws 58. The fixing pieces 32a and 34a are in contact with the ground of the board 28.

The inner second shell 34 has three fin pieces 60 which slantingly protrude outward from an upper surface and both side surfaces of the second shell 34. The fin pieces 60 elastically contact an upper surface and both side surfaces of the first shell 32 to close boundary portions between the second shell 34 and the first shell 32 and ensure electrical conduction therebetween. The fin pieces 60 may protrude inward from the first shell 32 and contact the second shell 34, but it is more convenient to provide the fin pieces 60 at the relatively larger second shell 34.

The receptacle connector 26A is fixed to the board 28 by the fixing pieces 32a and 34a and the first relay connector 40, and basically no soldering is made. Of these, the first relay connector 40 is mainly for electrical connection, and the fixing pieces 32a and 34a are mainly for mechanical connection. Therefore, no excessive force is applied to the first relay connector 40.

As illustrated in FIG. 3, an inner surface of the second shell 34 is opened to expose the terminal holder 44, but as illustrated in FIG. 4, the second shell 34 may have an inner wall 34b which covers the terminal holder 44.

In the laptop PC 10 and connector-board assembly 12 configured in this manner, the receptacle connector 26A and the board 28 are arranged so that the first relay connector 40 on the receptacle connector 26A side and the second relay connector 54 on the board 28 side are detachably connected to each other. Therefore, even if the receptacle connector 26A is damaged due to the application of an excessive force more than expected, it is possible to replace a relatively inexpensive receptacle connector 26A alone, and a relatively expensive board 28 can continue to be used as is, thereby making it possible to reduce the cost burden on a user.

Further, the holding body 38 of the receptacle connector 26A includes an electrode holder 42 on the electrode 36a side, a terminal holder 44 on the relay terminal 36b side, and an intermediate holder 46 therebetween. The intermediate holder 46 is inflexible and has volume elasticity. If a flexible sheet is applied to this portion, the shape is not be maintained, and hence the electrode holder 42 and the terminal holder 44 essentially become separate bodies. However, since the non-flexible intermediate holder 46 such as in the present embodiment maintains it shape, the electrode holder 42, the terminal holder 44, and the intermediate holder 46 become an integrated part and are easy to handle and assemble. As described above, the intermediate holder 46 is smaller than the electrode holder 42 and the terminal holder 44, and the receptacle connector 26A does not have to take on a special shape by providing the intermediate holder 46, and is kept small and almost the same size as the USB type C connector according to the related art.

In the holding body 38, some deviation in the relative positions of the electrode holder 42 and the terminal holder 44 is permitted due to the provision of the intermediate holder 46. Even if an excessive force more than expected is applied to the electrode holder 42 via the plug connector during and after the insertion of the plug connector, and the tongue portion 48 is damaged, the action of the external force is absorbed by the intermediate holder 46.

Further, since the electrode line 36 has the curved or bent portion between the two points of the boundary point P1 with the electrode holder 42 and the boundary point P2 with the terminal holder 44 at the folded portion 36c inside the intermediate holder 46, it is capable of absorbing the change in the path length between the two holders even if the external force from the plug connector is applied to the electrode holder 42 to cause a change in the relative position with the terminal holder 44. The folded portion 36c is capable of absorbing changes in three orthogonal directions and three twisting directions. Therefore, the terminal holder 44 is hardly affected, and the board 28 is not damaged via the terminal holder 44.

The electrode holder 42, the terminal holder 44, and the intermediate holder 46 have approximately the same relative dielectric constant and can suppress a transmission loss when a high-speed signal flows through the electrode line 36.

The receptacle connector 26A includes a first shell 32 made of a metal material which covers the plug holding cylindrical body 30 and fixes it to the board 28, and a second shell 34 made of a metal material which covers the terminal holder 44 and fixes it to the board 28. The receptacle connector 26A can protect the holding body 38 and obtain an electromagnetic shielding effect. Further, since the first shell 32 and the second shell 34 are separate bodies, the external force applied to each of the plug holding cylindrical body 30 and the electrode holder 40 is not transmitted to the terminal holder 44.

Since the boundary portion between the first shell 32 and the second shell 34 is closed by each fin piece 60 which protrudes from one side to the other, it is possible for them to suppress electromagnetic leakage from this boundary portion.

The first relay connector 40 and the second relay connector 54 have the floating structure capable of absorbing the tolerance between the relay terminals 36b and 54a. Therefore, even if the force of the electrode holder 42 acts on the terminal holder 44, the force is absorbed by the floating structure and has no effect on the board 28.

The receptacle connector 26B according to the second embodiment will next be described. Regarding the receptacle connectors 26B and 26C, the same components as those of the above-described receptacle connector 26A are designated by the same reference numerals, and their detailed description will be omitted.

FIG. 10 is an exploded perspective view of the receptacle connector 26B, the board 28, and the chassis 14. FIG. 11 is a view of the receptacle connector 26B as seen from the outside. FIG. 12 is a perspective view of the receptacle connector 26B, the board 28, and the chassis 14 as viewed from the inside. The screws 58 are omitted in FIG. 12.

The receptacle connector 26A is of a so-called top mount type, whereas the receptacle connector 26B is of a so-called mid mount type in which it fits into a notch 28d formed in the board 28. The receptacle connector 26B has the plug holding cylindrical body 30 which fits into the notch 28d, the terminal holder 44 is positioned above the board 28 in a manner similar to the above example, and the first relay connector 40 is inserted into and removed from the second relay connector 54 in the vertical direction.

The receptacle connector 26B has a metal shell 62. The shell 62 corresponds to the above-described shells 32 and 34 and has the effect of electromagnetic shielding and fixing to the board 28. The shell 62 has a cylindrical portion 62a which covers the periphery of the plug holding cylindrical body 30, and an inner top plate 62b located inside the cylindrical portion 62a. The plug holding cylindrical body 30 and the cylindrical portion 62a are fixed together by claws 30c. The lower halves of the plug holding cylindrical body 30 and the cylindrical portion 62a fit into the notch 28d.

The inner top plate 62b is located slightly higher than the cylindrical portion 62a, and the two connected by a step wall 62c. The inner top plate 62b has downwardly bent pieces 62d at both ends thereof. The inner top plate 62b, the step wall 62c, and the bent pieces 62d cover the terminal holder 44 but are not fixed thereto. Therefore, no external force is transmitted between the plug holding cylindrical body 30 and the terminal holder 44.

Portions extending from the upper surface to the side surfaces on both sides of the cylindrical portion 62a are cut into a square rectangular shape and folded back laterally to form fixing pieces 64R and 64L. In FIGS. 10 and 11, the right side is assumed to be the fixing piece 64R, and the left side is assumed to be the fixing piece 64L. The fixing pieces 64R and 64L correspond to the above-described fixing piece 32a, and the receptacle connector 26B is fixed to the board 28 by the fixing pieces 64R and 64L. The fixing piece 64R is formed with a screw hole through which the screw 58 is inserted, but the fixing piece 64L is not a hole but has a shape which opens to the side.

Next, the receptacle connector 26C according to the third embodiment will be described.

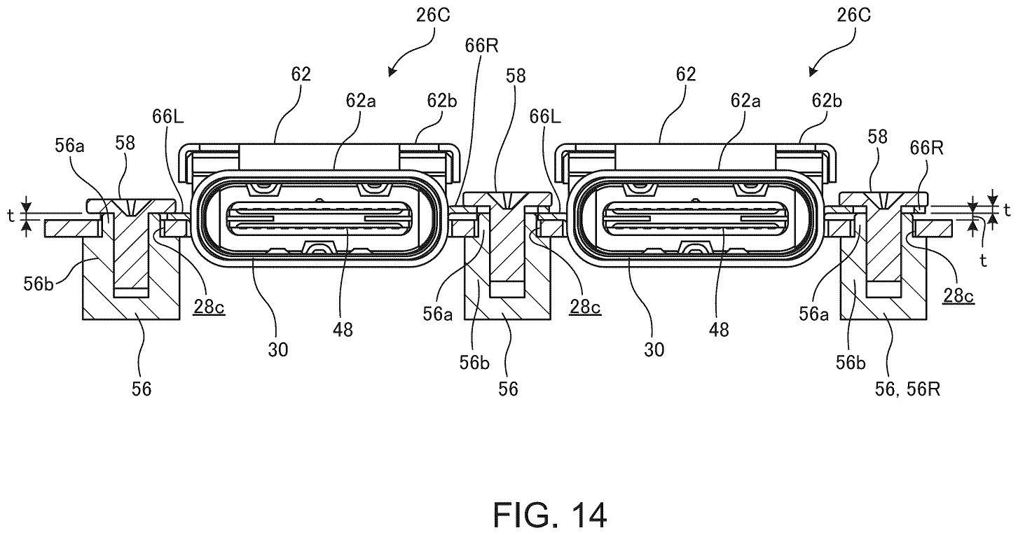

FIG. 13 is a perspective view illustrating a state in which two receptacle connectors 26C are mounted on a board 28. FIG. 14 is a view illustrating the state of mounting of the two receptacle connectors 26C on the board 28 as viewed from the outside. In each receptacle connector 26C, the fixing pieces 64R and 64L in the above receptacle connector 26B are replaced with fixing pieces 66R and 66L. The two receptacle connectors 26C are mounted side by side along the surface of the board 28 as viewed from the outside.

The two fixing pieces 66R and 66L are different in height. Specifically, the right fixing piece 66R is positioned higher in the surface normal direction than the left fixing piece 66L with the board 28 as a reference. A difference in height therebetween is equal to a plate thickness t of each of the fixing pieces 66R and 66L, but may be adjusted by a spacer or the like. The left fixing piece 66L of the adjacent right receptacle connector 26C and the right fixing piece 66R of the left receptacle connector 26C overlap with each other, and are fixed by common screws 58 and studs 56. In FIG. 14, the stud 56R (refer to FIG. 14) supporting the fixing piece 66R in the right receptacle connector 26C has a small diameter portion 56a which is higher by the plate thickness t than the other studs 56, and supports the receptacle connector 26C to be parallel to the board 28.

The receptacle connector 26C is fixed by the fixing pieces 66R and 66L rather than soldering to make the receptacle connector 26C replaceable relative to the board 28, but when mounting multiple receptacle connectors adjacent to each other, the total dimension in the parallel direction thereof can be suppressed by overlapping the fixing pieces 66R and 66L. The receptacle connector 26C may be mounted in three or more units in a row while overlapping the fixing pieces 66R and 66L, or may be mounted with only one unit. When the receptacle connector 26C is provided with a member equivalent to the second shell 34 in the above receptacle connector 26A, the two fixing pieces 34a of the second shell 34 may be different in height like the fixing pieces 66R and 66L. The receptacle connectors 26C illustrated in FIGS. 13 and 14 are of the mid-mount type, but may be of the top-mount type.

The present invention is not limited to the above-described embodiments, and can of course be freely modified within the scope not departing from the spirit of the present invention.

### DESCRIPTION OF SYMBOLS

10 laptop PC (electronic apparatus)
12 connector-board assembly
26, 26A, 26B, 26C receptacle connector
28 board
28d notch
30 plug holding cylindrical body
32 first shell
34 second shell
32a, 34a fixing piece
36 electrode line
36a electrode
36b, 54a relay terminal
36c folded portion
38 holding body
40 first relay connector
42 electrode holder
44 terminal holder
46 intermediate holder
48 tongue portion
52, 52A board-to-board connector
54 second relay connector
56, 56R stud
56a small diameter portion
56b large diameter portion
58 screw
60 fin piece
62 shell
64L, 64R fixing piece
P1, P2 boundary point

What is claimed is:

1. A connector-board assembly comprising:
a receptacle connector; and
a board mounted with the receptacle connector,
wherein the receptacle connector and the board are arranged so that a first relay connector on the receptacle connector side and a second relay connector on the board side are detachably connected to each other,
wherein the receptacle connector includes:
an electrode line continuously extending from an electrode connected to a plug-side electrode to a relay terminal of the first relay connector, and
a holder which covers and holds the electrode line between the electrode and the relay terminal.

2. The connector-board assembly according to claim 1, wherein the holder includes:
an electrode holder on the side of the electrode,
a terminal holder on the side of the relay terminal, and
an intermediate holder between the electrode holder and the terminal holder, and
wherein the intermediate holder is inflexible and has volume elasticity.

3. The connector-board assembly according to claim 2, wherein the electrode line has a curved or bent portion inside the intermediate holder between two points of a boundary point with the electrode holder and a boundary point with the terminal holder.

4. The connector-board assembly according to claim 2, wherein the electrode holder, the terminal holder, and the intermediate holder are approximately equal in relative dielectric constant.

5. The connector-board assembly according to claim 2, wherein the receptacle connector includes:
a plug hooding cylindrical body into which a plug is inserted,
a first shell made of a metal material, which covers the plug holding cylindrical body and fixes the same to the board, and
a second shell made of a metal material, which covers the terminal holder and fixes the same to the board, separately from the first shell.

6. The connector-board assembly according to claim 5, wherein a boundary portion between the first shell and the second shell is closed by a fin piece which protrudes from one shell to the other.

7. The connector-board assembly according to claim 1, wherein two or more of the receptacle connectors are arranged along the surface of the board as viewed from the side into which the plug is inserted, and each have protruding fixing pieces on both sides for fixing to the board,
wherein the fixing pieces protruding from both sides are different in position in a surface normal direction with the board as a reference, and
wherein the other fixing piece of the adjacent one of the receptacle connectors and the other fixing piece of the adjacent other of the receptacle connectors overlap with each other.

8. The connector-board assembly according to claim 1,
wherein the first relay connector and the second relay connector have a floating structure capable of absorbing the tolerance between relay terminals.

9. An electronic apparatus comprising:
a receptacle connector; and
a board mounted with the receptacle connector,
wherein the receptacle connector and the board are arranged so that a first relay connector on the receptacle connector side and a second relay connector on the board side are detachably connected to each other, and
wherein the receptacle connector includes:
an electrode line continuously extending from an electrode connected to a plug-side electrode to a relay terminal of the first relay connector, and
a non-flexible holder which covers and holds the electrode line between the electrode and the relay terminal.
